(19) United States
(12) Patent Application Publication
(10) Pub. No.: US 2005/0124736 A1
(43) Pub. Date: Jun. 9, 2005

(54) Compositions based on aqueous dispersions jof bitumen and polyurethane method for the preparation thereof and uses thereof

(76) Inventors: Evelyne Bonnet, Lamorlaye (FR); Laurent Martin, Tokyo (JP)

Correspondence Address: COZEN O'CONNOR, P.C., 1900 MARKET STREET, PHILADELPHIA, PA, 19103-3508, US

(21) Appl. No.: 10/504,827

(22) PCT Filed: Dec. 23, 2002
(86) PCT No.: PCT/FR02/04531

(30) Foreign Application Priority Data
Feb. 18, 2002 (FR) 02/02093

(51) Int. Cl. B05D 3/02; C08K 3/00

(52) U.S. Cl. 524/59; 427/372.2; 524/839

(57) ABSTRACT

The invention relates to an aqueous polymer composition containing at least one aqueous bitumen dispersion and at least one aqueous dispersion of at least one polyurethane obtained from a polyol component which contains at least one hydroxylated polydiene, a method for the preparation thereof by simply mixing two aqueous dispersions, and the use of said composition in several applications such as the productions of surface dressings, waterproof layers applied underneath road surface dressings, watertight roof coatings, road surface dressings, and sound damping and shock absorbing or insulating coatings. Bitumen that has been modified according to the inventive method has a very high threshold and improved mechanical properties. The inventive aqueous dispersions is also stable during storing and makes it possible to obtain a film by simply evaporating water.

The present invention relates to the field of emulsified asphalts, in particular to the field of asphalts in the form of an emulsion (or aqueous dispersion) that are modified by an aqueous polymer dispersion and more particularly to the field of emulsified asphalts modified by an aqueous dispersion of a specific polyurethane.

The use of asphalt-polymer blends is well known, particularly in the road field and in the waterproofing field, in particular in the form of membranes and coatings. The incorporation of polymers into asphalts modifies their properties so as to improve the thermal behaviour, which is characterized by an increase in the flow (creep) temperature and by a reduction in the stiffening (cracking) temperature, with as a consequence an improvement in the elongation, the tensile strength and the tear strength.

Among the various industrial applications of asphalt emulsions, mention may be made, for example, of the production of surface coats, waterproof courses under asphalt road mixes, asphalt road mixes, slurry seals or cold cast mixes, agglomeration binders, protective coverings for pipes, carpet underlay impregnation and tie layers, soundproofing and damping coverings. In all cases, these involve a dispersion of asphalt or bituminous substance in an aqueous phase obtained using a surfactant and by supplying energy provided either by a colloidal mill or by any other device suitable for forming the dispersion. In general, and depending on the type of emulsifier used in preparing the emulsion, two types of emulsions may be distinguished, namely anionic aqueous emulsions and cationic aqueous emulsions.

The first (i.e. anionic) emulsions generally find their applications in the building and public works (BPW) sector or the construction and civil engineering sector for waterproof membranes, bonding coats and external protective coatings. In particular, they are very widely used in the field of roofing membranes (for flat roofs and built-up roofs). The essential properties for these applications are the elasticity of the asphalt, good high-temperature resistance (low creep) and good low-temperature resistance (cracking resistance), and also good adhesion to steel and concrete substrates and low water absorption (i.e. good impermeability). This is because the asphalts used in roofing membranes must withstand large seasonal variations in temperature with lifetimes of several years. Emulsified asphalts not modified by a polymer additive do not in general result in satisfactory performance. This is because the mechanical properties of asphalts are very temperature-sensitive. They often become too rigid and brittle at winter temperatures, whereas they have a tendency to creep at high temperatures, for example in the summer. Moreover, asphalts generally have a low adhesion to conventional substrates, such as concrete and steel. It is therefore often necessary to apply a primer layer, which entails additional production costs. Finally, their impermeability and their chemical resistance are often insufficient.

The second (i.e. cationic) emulsions are used in general as a binder in the construction or repair of road pavements. The properties that it is desired to improve are therefore the rutting resistance (i.e. the ability of the asphalt to withstand abrasion, creep and ageing induced by vehicular traffic), low-temperature cracking resistance and adhesion to the aggregates.

U.S. Pat. No. 4,724,245 discloses a method that consists in preparing a blend of asphalt and hydroxytelechelic polybutadiene denoted hereafter by HTBD, and in emulsifying it in aqueous phase, the crosslinking taking place by addition of polyisocyanate dispersed in aqueous phase.

U.S. Pat. No. 3,909,474 discloses a similar method based on a preoxidized asphalt, the crosslinking taking place by oxidation of the HTBD.

U.S. Pat. No. 3,932,331 discloses a method for rapidly breaking and hardening an asphalt emulsion by incorporating therein an isocyanate (NCO)-terminated urethane prepolymer. When the prepolymer is added to the asphalt emulsion, this makes it impossible to store the asphalt-polymer emulsion blend since the isocyanate reacts with the water of the emulsion.

DE 40939151 discloses a composition obtained by the reaction of a prepolymer with a dispersion of an unsaturated olefin compound, of polyurethane or of asphalt.

DE 4408154 discloses a coating based on an asphalt emulsion containing a polyurethane prepolymer with NCO terminal groups.

Most of these methods, known in the prior art, require the use of reactive two-component (2K) compositions with the necessary presence of an isocyanate component and strict control of the operating conditions both from the environmental/health/safety standpoint and the technical standpoint in terms of strict dosing of the reactive components in order to achieve satisfactory performance. More particularly, owing to the application conditions often imposed (e.g. environmental constraints: temperature and humidity), the structure and the applicative performance of the end product are often very difficult to reproduce. Moreover, the changing reaction of the isocyanate component may very well disturb the fragile stability of the dispersion in its entirety.

The present invention remedies these problems by proposing a solution based on an aqueous polymer composition equivalent to a nonreactive one-component (1 K) composition. Indeed, there is complete absence of a reactive component liable to be affected by the operating conditions during application or to affect its processing conditions in terms of health, safety or the environment by its use.

The first subject of the present invention is therefore an aqueous polymer composition comprising:
a) at least one aqueous asphalt dispersion; and
b) at least one aqueous dispersion of at least one polyurethane, this polyurethane being obtained from a polyol component containing at least one hydroxylated polydiene.

Another subject of the invention is a method of preparation of the composition defined according to the invention, by simple physical blending of an aqueous asphalt dispersion with an aqueous polyurethane dispersion, the two emulsions being compatible. This method makes it possible to modify the asphalt and to improve all of its properties, and consequently to offer novel technical solutions in the BPW membrane sector and the construction and civil engineering sector. This method has the advantage of proposing a one-component system containing no free isocyanate (free NCO), which is homogeneous and stable. In addition, the asphalt-polymer film forms and hardens by simple water evaporation under the ambient application conditions.

Another subject of the invention is a coating composition comprising at least one aqueous polymer composition as defined according to the invention.

Another subject of the invention is the use of an aqueous polymer composition of the invention in the production of surface coats, waterproof courses under asphalt road mixes, roofing membranes, asphalt road mixes, slurry seals or cold cast mixes, agglomeration binders, protective coverings for pipes, carpet underlay impregnation and tie layers, soundproofing and damping or insulating coverings.

The invention also relates to a method of use of the aqueous polymer composition as defined according to the invention, which comprises the following steps:
a) blending of at least one aqueous asphalt dispersion with at least one aqueous dispersion of at least one polyurethane as defined according to the invention;
b) direct application of the blend obtained in step a) to the application object or substrate;
c) drying/film-forming by simple water evaporation; it being possible for the three steps a), b) and c) to be carried out on the actual site of the application and under the ambient conditions of the application site.
A final subject of the invention relates to end products such as coatings, surface coats, waterproof courses under asphalt road mixes, roofing membranes, asphalt road mixes, slurry seals or cold cast mixes, agglomeration binders, protective coverings for pipes, carpet underlay impregnation and tie layers, soundproofing and damping or insulating coverings obtained according to the method of use of the invention or from an aqueous polymer dispersion composition as defined according to the invention.

Specifically, the Applicant has discovered that the addition of an aqueous polyurethane dispersion, denoted hereafter by PUD, into an aqueous asphalt dispersion (emulsion) makes it possible to obtain a storage-stable blend and to very significantly improve the mechanical performance in terms of thermal withstand at low and high temperatures (stiffening problem and creep resistance) and in particular the mechanical properties, such as the tensile strength and the elongation at the break of the modified asphalt that results from the presence of the PUD. In addition, the properties of adhesion of the asphalt to steel or concrete are considerably improved, as is the water vapor impermeability for applications such as membrane or sealing layers.

The Applicant has also discovered that when the polyurethane dispersion is produced from a hydroxytelechelic polybutadiene (HTBD), the chemical resistance properties are particularly improved.

According to the invention, the aqueous polyurethane dispersion may be prepared using a method described in WO 99/4894, which comprises the following steps:
(a) formation of a prepolymer having NCO functional groups by reaction in a solvent:
   of a polyisocyanate component, and
   of a polyol component comprising a diol, carrying at least one neutralized acid functional group, the NCO functional groups being in excess relative to the OH functional groups, and in a ratio of between 1.5 and 2.5,
(b) dispersion of the prepolymer in water,
(c) addition of a diamine-type chain extender, and
(d) evaporation of the solvent in order to obtain an aqueous polyurethane dispersion containing urea functional groups.

The polyurethane component of the aqueous polymer dispersion composition according to the invention represents from 2 to 50% and preferably from 5 to 25% by weight relative to the total asphalt+polyurethane weight, the weight being expressed as dry matter.

Preferably, the hydroxylated polydiene is chosen from hydroxytelechelic conjugated-diene oligomers that can be obtained by various methods such as the radical polymerization of conjugated dienes having from 4 to 20 carbon atoms in the presence of a polymerization initiator, such as hydrogen peroxide or an azo compound, such as 2,2′-azobis[2-methyl-N-(2-hydroxyethyl)propionamide], or the anionic polymerization of conjugated dienes having from 4 to 20 carbon atoms in the presence of a catalyst, such as dilithium naphthalene.

According to the present invention, the polyol component of the polyurethane consists of at least 50% and preferably at least 80% by weight of at least one hydroxytelechelic conjugated-diene oligomer. This is preferably selected from hydroxytelechelic oligomers derived from: butadiene, isoprene, chloroprene, 1,3-pentadiene, cyclopentadiene and mixtures thereof. The number-average molecular weight of the oligomers that can be used may vary from 500 to 15 000 and preferably from 1000 to 3000, the hydroxyl number expressed in milliequivalents per gram (meq/g) is from 0.5 to 5 and preferably from 0.7 to 1.8, and their viscosity is between 1000 and 10 000 mpa.s.

Preferably, a butadiene-based and more particularly hydroxytelechelic polydiene-polyol will be used. Advantageously, the polydiene-polyol comprises 70 to 85 mol %, preferably 80 mol %, of 1-4 units and 15 to 30 mol %, preferably 20 mol % of 1-2 units. As an illustration of polydiene-polyols, mention may be made of hydroxyl-terminated polybutadiene sold by Atofina under the brand names PolyBd®R45 HT and PolyBd®R20 LM. Hydroxylated copolymers of conjugated dienes with vinyl and/or acrylic monomers, such as styrene or acrylonitrile, may also be suitable as hydroxylated polydienes. Likewise, in-chain-epoxidized hydroxytelechelic butadiene oligomers or else hydroxytelechelic conjugated-diene oligomers, when partially or completely hydrogenated, may be suitable for this use.

The diol carrying at least one neutralized acid functional group may be triethylamine-neutralized dimethylolpropionic acid.

A short diol may also form part of the polyol component used for the preparation of the polyurethane. As examples of such diols, mention may be made of 2-ethyl-1,3-hexanediol, N,N′-bis(2-hydroxypropyl) aniline. The amount of such a diol is advantageously between 1 and 30 parts by weight per 100 parts of hydroxyl-terminated polydiene.

According to the present invention, the polyisocyanate used for the preparation of the aqueous polyurethane dispersion may be an aromatic, aliphatic or cycloaliphatic polyisocyanate having at least two isocyanate functional groups in its molecule.

A way of illustration of aromatic polyisocyanates, mention may be made of 4,4′-diphenylmethane diisocyanate (MDI), liquid modified MDIs, polymeric MDIs, 2,4- and 2,6-tolylene diisocyanate (TDI) and mixtures thereof, xylylene diisocyanate (XDI), triphenylmethane triisocyanate, tetramethylxylylene diisocyanate (TMXDI), paraphenylene diisocyanate (PPDI) and naphthalene diisocyanate (NDI).

Among the aromatic polyisocyanates, the invention preferably relates to 4,4′-diphenylmethane diisocyanate and most particularly to liquid modified MDIs.

By way of illustration of aliphatic polyisocyanates, mention may be made of hexamethylene diisocyanate (HDI), and its derivatives, trimethylhexamethylene diisocyanate.

By way of illustration of cycloaliphatic polyisocyanates, mention may be made of isophorone diisocyanate (IPDI), and its derivatives, 4,4′-dicyclohexylmethane diisocyanate and cyclohexyl diisocyanate (CHDI).

A catalyst may be added, which may be chosen from the group comprising tertiary amines, imidazoles and organometallic compounds.

By way of illustration of a tertiary amine, mention may be made of diaza-1,4-bicyclo[2.2.2]octane (DABCO).

By way of illustration of organometallic compounds, mention may be made of dibutyltindilaurate and dibutyltindiacetate.

The amounts of catalyst may be between 0.01 and 5 parts by weight per 100 parts by weight of polyol (hydroxyl-teminated polydiene and diol with an acid functional group).

The amount of isocyanate is advantageously such that the NCO/OH molar ratio is greater than 1.4 and preferably between 1.5 and 2.5. The OH functional groups are those of hydroxylated polydiene and of the diol with an acid functional group and of the short diol.

The amount of diol containing neutralized acid functional groups is advantageously such that there are 0.2 to 2.5 carboxylate functional groups per hydroxyl-terminated polydiene chain. The presence of a solvent is necessary in order to allow the prepolymer to be synthesized, this solvent having to be easy to remove in step (d). It is preferred to use methyl ethyl ketone (MEK). This step (a) is carried out in conventional stirred reactors.

The amount of water in step (b) is such that, in step (d), a dispersion containing from 20 to 60 and preferably from 30 to 50 wt % of solid matter (SC:Solids Content) is obtained. In step (b), the water is advantageously introduced into a stirred reactor. This step (b) may or may not be carried out under pressure, but it is simpler to be at atmospheric pressure. The temperature of this step may vary from room temperature (20° C.) to 80° C., and it is preferably at room temperature (20° C.).

As chain extender in step (c), mention may be made of a diamine-type extender and more particularly hydrazine in aqueous solution or ethylenediamine or isophoronediamine or hydroxylamine. The extension reaction may be carried out at a temperature ranging from room temperature to 80° C., and preferably at room temperature and at atmospheric pressure. The extension of the chains in the dispersion may be monitored by volumetric analysis of the isocyanate functional groups over the course of time. The reaction time is around 10 minutes.

Step (d) may be carried out, for example, by a distillation using a standard device.

The aqueous dispersions obtained do not contain a substantial amount of solvent (preferably less than 5%), they have a low viscosity, for example from 4 to 10 mpa.s and they have a solids content (SC) of 20 to 60% and preferably of 30 to 50% by weight.

As regards the method of preparation of the aqueous polymer composition according to the invention, the proportions of the respective asphalt and polyurethane dispersions are in a weight ratio ranging from 2 to 75% of dispersion, for asphalt and polyurethane dispersions having solids contents that can be independently varied within a range from 20 to 60% by weight, and preferably from 30 to 50% by weight, of each dispersion.

As regards the coating compositions according to the invention, these may serve for the production of coatings or coats for protection, sealing or waterproofing, soundproofing, or damping, for road and roof applications, in buildings or in industry.

The following examples illustrate the invention without limiting the scope thereof.

### EXAMPLES

An aqueous polyurethane dispersion was typically obtained from an isocyanate-terminated urethane prepolymer containing anionic (i.e. carboxylic) or cationic functional groups so as to allow emulsification. This prepolymer was firstly neutralized and dispersed in water. The next step consisted in increasing the molecular weight or carrying out a chain extension by the addition of a diamine in order to obtain a polyurea polyurethane (PUD) dispersion. It would have been possible, for example, without this being restrictive as regards the type of PUD covered by the present patent, to choose an anionic PUD obtained from a hydroxylated polybutadiene as described in patent application Ser. No. FR 98/03793.

Aqueous polyurethane dispersion

| Composition | Anionic polyurethane dispersion based |
|---|---|
| | on hydroxylated polybutadiene (PolyBd |
| | R45HT ® from Atofina) |
| Solids content | 37.9% by weight |
| pH | 7.3 |

This aqueous polyurethane dispersion was added to an asphalt in aqueous emulsion with an uncharged cellular structure (the emulsion being able to be used as a multipurpose asphalt-based coating for sealing, bonding, insulating, protecting and tiling). These two emulsions were blended at room temperature using a blade stirrer rotating at low speed for 10 minutes in the following proportions by weight [m1, m2]: [0, 100], [5, 95], [10, 90], [20, 80], [50,50], [75, 25] and [100, 0], where m1 represents the mass of aqueous PUD polyurethane dispersion and m2 the mass of asphalt emulsion.

Asphalt emulsion

| Composition | Anionic asphalt emulsion |
|---|---|
| Solids content | 48% by weight |
| pH | 9.5 |

Storage Stability

The storage stability of the emulsion blends was monitored over a period of 1 month at room temperature. It was possible to obtain stable blends with PUD contents ranging up to 50 parts by weight per 50 parts by weight of asphalt dispersion, no phase separation being observed. The storage stability is therefore deemed to be good. The results are given in detail in Table 1 below.

TABLE 1
Evaluation of the stability of the blend as a function of the PUD/asphalt
dispersion composition after being stored for one month.

| | | | | | | | |
|---|---|---|---|---|---|---|---|
| PUD (parts by weight) | 0 | 5 | 10 | 20 | 50 | 75 | 100 |
| Asphalt emulsion | 100 | 95 | 90 | 80 | 50 | 25 | 0 |
| (parts by weight) | | | | | | | |
| 1 month at room | Sta- | Sta- | Sta- | Sta- | Sta- | Un- | sta- |
| temperature | ble | ble | ble | ble | ble | stable | ble |

Evaluation of the Hot and Cold Properties

All the specimens were analyzed by DMA so as to monitor the change in the properties with temperature and more precisely to determine the influence of the PUD modifier content on the upper and lower operating limits of the asphalt. The moduli E′ (dynamic storage modulus) and E″ (dynamic loss modulus), and also the loss factor tan δ(=E″/E′), were measured by DMA analysis between −100° C. and +100° C. at a frequency ω of 10 rad.s⁻¹.

A high temperature limit was able to be demonstrated. This temperature corresponds to the flow point of the asphalt, and beyond this point the properties of the specimen could no longer be measured and the test was therefore stopped. In the case of the [100/0] asphalt, the flow point, as defined above, was at T[100/0]=31° C. This temperature clearly increases when the bitumen is modified by the PUD (“asphalt emulsion”/“PUD” parts by weight in brackets). Thus, a T[95/5] of 54.7° C. was obtained and then a T[90/10] of 66.7° C. and a T[80/20]>100° C. were obtained, as indicated in Table 2.

As in the case of the determination of a low temperature limit, we set a stiffening criterion T* as being the temperature at which the modulus E′ (dynamic storage modulus determined by DMA at the frequency ω of 10 rad.s−1) of the modified asphalt increases by half a decade relative to the modulus E′ at room temperature (RT=20° C.). According to this criterion, we therefore obtained a T* [100/0] of +4° C. in the case of the control asphalt and then a T* [95/5] of −18.1° C., a T* [90/10] of −9.9° C., a T* [80/20] of −11.9° C., a T* [50/50] of −32.6° C. and finally a T* [25/75] of −53.3° C. in the case of the modified asphalts.

TABLE 2
Measurement of the flow and stiffening temperatures as a function of the
PUD/asphalt dispersion composition (PU: dry polyurethane)

| Anionic HTBD-based | | 0 | 5 | 10 | 20 | 50 | 75 | 100 |
|---|---|---|---|---|---|---|---|---|
| polyurethane disper- | | | | | | | | |
| sion (parts by weight) | | | | | | | | |
| Anionic asphalt emul- | | 100 | 95 | 90 | 80 | 50 | 25 | 0 |
| sion (parts by weight) | | | | | | | | |
| Amount in % of dry | | 0 | 3.98 | 8.06 | 16.48 | 44.12 | 71.64 | 100 |
| polyurethane (PU) | | | | | | | | |
| in the blend | | | | | | | | |
| (solids ratio by weight) | | | | | | | | |
| T (flow point) | ° C. | 31 | 54.7 | 66.7 | >100 | >100 | >100 | >100 |
| T* (stiffening | ° C. | 4 | −18.1 | −9.9 | −11.9 | −32.6 | −53.3 | −62.2 |
| point) | | | | | | | | |

These measurements clearly show that the plasticity range of the control asphalt is widened by the use of PUD as modifier. The high-temperature properties (i.e. creep) are improved as is the low-temperature cracking resistance.

Evaluation of the Adhesion to Steel

The various PUD-modified asphalt emulsions were then applied as a 1 mm thick film to steel. The steel substrate selected was a conventional steel (low-carbon mild steel) surface-treated beforehand by shot peening. An adhesion-to-steel test was carried out according to the Renault D51 1755 standard, which consists in adhesively bonding a circular stud with a diameter Ø of 20 mm to the coating by means of a two-component epoxy adhesive (ARALDITE from Ciba-Geigy). This stud was then pulled at a rate of 10 mm/min on a tensile testing machine in the arrangement described below. The maximum tear force and the failure mode (cohesive or adhesive failure) were then noted.

The asphalt alone showed only very weak adhesion to shot-peened steel. When the amount of modifier was increased, the adhesion improved very substantially. An adhesion of 1.38 MPa obtained for the [5/95] PUD/asphalt emulsion blend was 1.38 MPa, then 3.37 MPa for the [20/80] blend and greater than 4 MPa for the [50/50] and [75/25] blends. The results are given in Table 3.

Evaluation of the Adhesion to Concrete

For these tests, we used concrete slabs of dimension 40×40×5 cm of the LUCIANA reference type. They were dedusted and rinsed in water beforehand, and then placed for at least 24 hours in fan oven at 50° C. in order to dry them. The various PUD-modified emulsions were then poured onto the concrete slab to form a coating about 1 mm in thickness. The coated slab was left for one week at ambient temperature and humidity. An adhesion test as described above was then carried out. The results confirmed that the adhesion properties of the asphalt are improved by the addition of PUD, particularly with contents of between 10 and 20%, for which cohesive failure in the concrete substrate was observed. The results are given in the summarizing Table 3.

Evaluation of the Water Vapor Permeability

Films 2 mm in thickness were produced from the various PUD-modified asphalt emulsions. The specimens were placed for 2 hours in a fan oven at 50° C. and then for one week at room temperature in the laboratory in order to complete the film-forming process, before being cut into test pieces. The water vapor permeability measurements were carried out according to the ASTM E 96 E standard (38° C./90% relative humidity RH). A considerable improvement in the impermeability properties of the film was observed thanks to the use of PUD. The results are given in the summarizing Table 3.

Evaluation of the Mechanical Properties

Films 2 mm in thickness were produced from the various PUD-modified asphalt emulsions. The specimens were placed for 2 hours in a fan oven at 50° C. and then for one week at room temperature in the laboratory in order to complete the film-forming process, before being cut into test pieces for the mechanical tests. The tensile strength was almost zero in the case of bitumen alone, whereas values well above 1 MPa were obtained with a dry PU (polyurethane) modifier polymer content of around 16%. This tensile strength, like the elongation at break, increases with increased PU modifier polymer content (see Table 3).

TABLE 3
Summary of the properties of the modified asphalts as a function of the PUD/asphalt dispersion composition

| Anionic HTBD-based | | 0 | 5 | 10 | 20 | 50 | 75 | 100 |
|---|---|---|---|---|---|---|---|---|
| polyurethane dispersion | | | | | | | | |
| (parts by weight) | | | | | | | | |
| Anionic asphalt emulsion | | 100 | 95 | 90 | 80 | 50 | 25 | 0 |
| (parts by weight) | | | | | | | | |
| Dry PU content in the | | 0 | 3.98 | 8.06 | 16.48 | 44.12 | 71.64 | 100 |
| blend (amount by weight | | | | | | | | |
| per 100 parts of solids) | | | | | | | | |
| Adhesion to steel | MPa | 0 | 1.38 | — | 3.37 | 4.63 | 4.16 | 7.9 |
| (Renault D51 | | | | | cohesive | cohesive | cohesive | cohesive |
| 1755) | | | | | asphalt | asphalt | asphalt | asphalt |
| Adhesion to | kN | 2.66 | 2.77 | 3.48 | 3.04 | 3.13 | 1.95 | 2.13 |
| concrete (Renault | | cohesive | cohesive | cohesive | cohesive | cohesive | adhesive | adhesive |
| D51 1755) | | asphalt | asphalt | concrete | concrete | concrete | | |
| Water vapor | g.500 μm/mm² | 295.2 | 247.5 | 102.4 | 103.38 | 16.68 | 15.7 | 26 |
| permeability | 24 h | | | | | | | |
| (ASTM E96E) | | | | | | | | |
| Tensile strength | MPa | ≈0 | ≈0 | ≈0 | 1.4 | 2.1 | 2.6 | 5.1 |
| (ASTM D412-98a) | | | | | | | | |
| Elongation at | % | ≈0 | ≈0 | ≈0 | 19 | 80 | 265 | 413 |
| break (ASTM D624- | | | | | | | | |
| 00e1) | | | | | | | | |
| Tear strength | N/mm | Not | Not | Not | 13.7 | 17.1 | 17.8 | 21.6 |
| (ASTM 2240-00) | | measurable | measurable | measurable | | | | |
| Hardness | Shore A | Not | Not | Not | 63 | 70 | 69 | 70 |
| | | measurable | measurable | measurable | | | | |
| T (flow point) | ° C. | 31 | 54.7 | 66.7 | >100° | >100° | >100° | >100° |
| T* (stiffening | ° C. | 4 | −18.1 | −9.9 | −11.9 | −32.6 | −53.3 | −62.2 |
| point) | | | | | | | | |

1. A aqueous polymer composition comprising a simple mixture of:
a) at least one aqueous asphalt dispersion; and
b) at least one aqueous dispersion of at least one polyurethane, said polyurethane being obtained from a polyol component comprising at least one hydroxylated polydiene, said aqueous polyurethane dispersion having previously and separately been prepared according to the following steps:
(a) formation of a prepolymer having NCO functional groups by reaction in a solvent of a polyisocyanate component, and a polyol component comprising a diol containing at least one neutralized acid functional group,
(b) dispersion of the prepolymer in water,
(c) addition of a diamine-type chain extender, and
(d) evaporation of the solvent in order to obtain an aqueous polyurethane dispersion containing urea functional groups.

2. The composition as claimed in claim 1, characterized in that at said polyol component comprises at least 50% of at least one hydroxytelechelic conjugated-diene oligomer.

3. The composition as claimed in claim 2, characterized in that said oligomer is selected from oligomers based on: butadiene, isoprene, chloroprene, 1,3-pentadiene or cyclopentadiene, or on mixtures thereof.

4. The composition as claimed claims 2, characterized in that said oligomer has a number-average molecular weight Mₙ of 500 to 15 000

5. The composition as claimed in claim 2, characterized in that said oligomer has a hydroxyl number expressed in meq/g of 0.5 to 5.

6. The composition as claimed in claim 1, characterized in that said diol includes at least one neutralized acid functional group.

7. The composition as claimed in claim 6, characterized in that said diol is triethylamine-neutralized dimethylolpropionic acid.

8. The composition as claimed in claim 1, characterized in that said polyisocyanate component comprises at least one aliphatic, aromatic or cycloaliphatic polyisocyanate having a functionality of at least two.

9. The composition as claimed in claim 1, characterized in that, the proportions of the polyisocyanate component and of the polyol component are such that the overall NCO/OH ratio is between 1.5 and 2.5.

10. The composition as claimed in claims 1, characterized in that said aqueous polyurethane dispersion is obtained with a chain extender selected from diamines.

11. The composition as claimed in claim 1, characterized in that said polyurethane represents from 2 to 50% by weight relative to the total asphalt+polyurethane weight, the weight being expressed as dry matter.

12. (canceled)

13. A method comprising blending of:
i) at least one aqueous asphalt dispersion and
ii) at least one aqueous dispersion of at least one polyurethane prepared according to the following steps:
(a) formation of a prepolymer having NCO functional groups by reaction in a solvent of a polyisocyanate component, and a polyol component comprising a diol containing at least one neutralized acid functional group,
(b) dispersion of the prepolymer in water,
(c) addition of a diamine-type chain extender, and
(d) evaporation of the solvent in order to obtain an aqueous polyurethane dispersion containing urea functional groups.

14. The method of preparation as claimed in claim 13, characterized in that the weight proportion of the polyurethane dispersion represents from 2 to 75% of the total of asphalt and polyurethane dispersions, the asphalt and polyurethane dispersions having independent solids contents varying within a range from 20 to 60% by weight of each dispersion.

15. (canceled)

16. (canceled)

17. The composition as claimed in claim 16, characterized in that said coating is a protective, sealing or waterproof, soundproofing or damping coat or coating for application for roads, roofing, in buildings or in industry.

18. A method of production of surface coats, waterproof courses under asphalt road mixes, roofing membranes, asphalt road mixes, slurry seals or cold cast mixes, agglomeration binders, protective coverings for pipes, carpet underlay impregnation and tie layers, soundproofing and damping or insulating coverings, characterized in that it comprises the following steps:
a) blending of at least one aqueous asphalt dispersion with at least one aqueous dispersion of at least one polyurethane prepared by
(i) formation of a prepolymer having NCO functional groups by reaction in a solvent of a polyisocyanate component, and a polyol component comprising a diol containing at least one neutralized acid functional group,
(ii) dispersion of the prepolymer in water,
(iii) addition of a diamine-type chain extender, and
(iv) evaporation of the solvent in order to obtain an aqueous polyurethane dispersion containing urea functional groups;
b) direct application of the blend obtained in step a) to the application object or substrate;
c) drying/film-forming by simple water evaporation; it being optional for steps a), b) and c) to be carried out on the actual site of the application and under the ambient conditions of the application site.

19. Coatings, surface coats, waterproof courses under asphalt road mixes, roofing membranes, asphalt road mixes, slurry seals or cold cast mixes, agglomeration binders, protective coverings for pipes, carpet underlay impregnation and tie layers, soundproofing and damping or insulating coverings obtained by the method as defined in claim 18.

20. The composition of claim 2 characterized in that at least 80% by weight of said polyol component consists of at least one hydroxytelechelic conjugated-diene oligomer.

21. The composition of claim 4 wherein said Mₙ is 1000 to 3000.

22. The composition of claim 5 wherein said hydroxyl number expressed in meq/g is 0.7 to 1.8.
